(19) United States
(12) Patent Application Publication
(10) Pub. No.: US 2016/0275555 A1
(43) Pub. Date: Sep. 22, 2016

(54) INFORMATION PROCESSING DEVICE, CONTENT DELIVERY METHOD, AND NON-TRANSITORY STORAGE MEDIUM STORING INFORMATION PROCESSING PROGRAM

(71) Applicant: Shuuichi NAKAMURA, Kanagawa (JP)

(72) Inventor: Shuuichi NAKAMURA, Kanagawa (JP)

(73) Assignee: RICOH COMPANY, LTD., Tokyo (JP)

(21) Appl. No.: 15/063,738

(22) Filed: Mar. 8, 2016

(30) Foreign Application Priority Data
Mar. 19, 2015 (JP) 2015-056205

(51) Int. Cl. G06Q 30/02

(52) U.S. Cl. CPC G06Q 30/0255; G06Q 30/0267

(57) ABSTRACT

An information processing device provides one or more functions to one or more terminal devices. The information processing device includes a content manger configured to store, for each of the one or more terminal devices, content data that is selected depending on a status of using each of the one or more functions by the terminal device in a data storage unit, while associating the content data with the terminal device; and a request reception processor configured to receive a request for processing from a specific terminal device of the one or more terminal devices, and configured to transmit, to the specific terminal device that is a request source, the content data associated with the specific terminal device, together with a processing result corresponding to the request.

### BACKGROUND OF THE INVENTION

1. Field of the Invention

The present invention relates to an information processing device, a content delivery method, and a non-transitory storage medium storing an information processing program.

2. Description of the Related Art

Recently, there are some mobile terminals, such as smartphones, that have advertising functions for displaying banner advertisements. For example, an advertising function included in a mobile terminal displays a banner advertisement that is selected depending on personal information, such as age and gender of a user, and location information of the mobile terminal.

In a WWW hyperlink system, there has been a banner advertisement management system for effectively managing a browsing status of banner advertisement data of a site that displays a banner advertisement on a home page. With such a banner advertisement management system, an advertiser can monitor a browsing status of the banner advertisement in real time (cf. Patent Document 1 (Japanese Unexamined Patent Publication No. 2000-215136, for example).

The banner advertisement management system displays, from historical data items, a banner advertisement such that an accessed user is likely interested in a content of the banner advertisement. Accordingly, the banner advertisement management system actively selects and displays, from historical data items, a banner advertisement with a content (e.g., a content that has been accessed by a user in past) for which a determination is made that the user is likely interested in the content of the banner advertisement.

However, an information processing device that provides a plurality of functions to a mobile terminal, such as a smartphone, may not select a content, such as a banner advertisement on a function of the information processing device, so as to cause the mobile terminal to display the content, depending on a usage status of the function of the information processing device.

There is a need for providing an information processing device that can cause a terminal device to display content depending on a usage status of a function provided to the terminal device by the information processing device.

### SUMMARY OF THE INVENTION

According to an aspect of the present invention, there is provided an information processing device configured to provide one or more functions to one or more terminal devices, the information processing device including a content manger configured to store, for each of the one or more terminal devices, content data that is selected depending on a status of using each of the one or more functions by the terminal device in a data storage unit, while associating the content data with the terminal device; and a request reception processor configured to receive a request for processing from a specific terminal device of the one or more terminal devices, and configured to transmit, to the specific terminal device that is a request source, the content data associated with the specific terminal device, together with a processing result corresponding to the request.

According to another aspect of the present invention, there is provided a content delivery method to be executed by an information processing device configured to provide one or more functions to one or more terminal devices, the content delivery method including storing, for each of the one or more terminal devices, content data that is selected depending on a status of using each of the one or more functions by the terminal device in a data storage unit, while associating the content data with the terminal device; and receiving a request for processing from a specific terminal device of the one or more terminal devices, and transmitting, to the specific terminal device that is a request source, the content data associated with the specific terminal device, together with a processing result corresponding to the request.

According to another aspect of the present invention, there is provided a non-transitory storage medium storing an information processing program, wherein an information processing device is configured to provide one ore more functions to one or more terminal devices, and the program causes the information processing device to function as a content manger configured to store, for each of the one or more terminal devices, content data that is selected depending on a status of using each of the one or more functions by the terminal device in a data storage unit, while associating the content data with the terminal device; and a request reception processor configured to receive a request for processing from a specific terminal device of the one or more terminal devices, and configured to transmit, to the specific terminal device that is a request source, the content data associated with the specific terminal device, together with a processing result corresponding to the request.

According to an embodiment of the present invention, content can be displayed on a terminal device, depending on a usage status of a function that is provided to the terminal device.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating an example of a configuration of an information processing system according to an embodiment;

FIG. 2 is a diagram illustrating an example of a hardware configuration of a computer according to the embodiment;

FIG. 3 is a diagram illustrating an example of processing blocks of an information processing device according to the embodiment;

FIG. 4 is a diagram illustrating an example of processing blocks of a content server device according to the embodiment;

FIG. 5 is a flowchart illustrating an example of a content delivery process executed by the information processing device;

FIG. 6 is a diagram illustrating an example of an arrangement of a table that defines correspondence between devices and content data items;

FIG. 7 is a sequence diagram illustrating an example of a process, by the information processing device, of retrieving content data from the content server device;

FIG. 8 is a flowchart illustrating an example of details of a process at step S26;

FIG. 9 is a diagram illustrating an example of an arrangement of aggregation data;

FIG. 10 is a diagram illustrating an example of an arrangement of display condition information; and

FIG. 11 is a sequence diagram illustrating an example of a process, by the information processing device, of delivering content data to a terminal device.

### DETAILED DESCRIPTION OF THE PREFERRED EMBODIMENTS

Next, an embodiment of the present invention is described in detail.

### Embodiment

### System Configuration

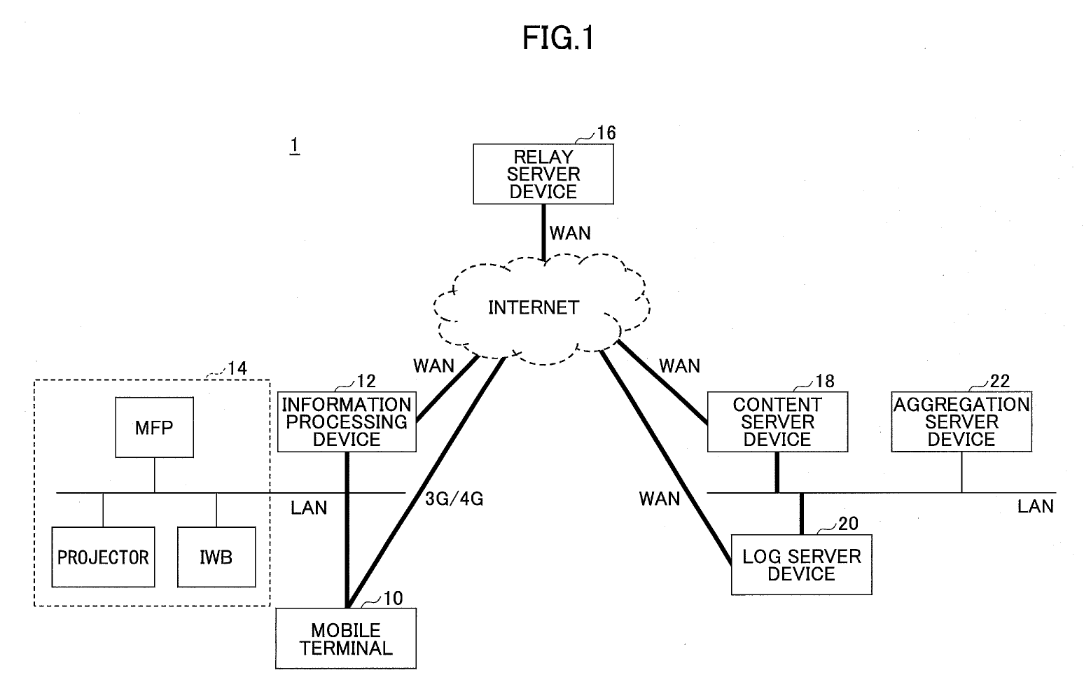

FIG. 1 is a diagram illustrating an example of a configuration of an information processing system 1 according to the embodiment. The information processing system 1 of FIG. 1 is configured such that a mobile terminal 10, information processing device 12, an electronic device 14, a relay server device 16, a content server device 18, a log server device 20, and an aggregation server device 22 that are included in the information processing system 1 are connected through various types of networks.

The relay server device 16 is connected to a network, such as the Internet or a wide area network (WAN). The relay server device 16 relays between the mobile terminal 10 and the information processing device 12. For a case where the mobile terminal 10 and the information processing device 12 are not connected to the same local area network (LAN), the relay server 16 connects the mobile terminal 10 to the information processing device 12 through a network, such as the Internet. In response to detecting that there is a request to be transmitted to the information processing device 12, the mobile terminal 10 transmits, to the relay server device 16, information for identifying the mobile terminal 10; the request; and information for identifying the information processing device 12.

The relay server device 16 associates the received request with the information for identifying the mobile terminal 10 and the information for identifying the information processing device 12; and the relay server device 16 stores, in a queue, for example, the received request and the associated information for identifying the mobile terminal 10 and the associated information for identifying the information processing device 12. The information processing device 12 obtains, by polling, the request stored in the relay server 16 and the information for identifying the mobile terminal 10 that transmits the request. The information processing device 12 executes a process corresponding to the request; and the information processing device 12 transmits, to the relay server device 16, a processing result, together with the information for identifying the mobile terminal 10 that transmits the request.

The relay server device 16 associates the received processing result with the information for identifying the mobile terminal 10 that transmits the request; and the relay server device 16 stores the received processing result and the associated information for identifying the mobile terminal 10. The mobile terminal 10 that transmits the request can obtain, from the relay server 16, the processing result that corresponds to the request transmitted to the relay server device 16.

A general purpose operating system (OS) may be, installed in the information processing device 12. The information processing device 12 is connected the electronic device 14, such as a multifunction peripheral (MFP), a projector, or an electronic whiteboard (IWB), through a network, such as a local area network (LAN). The information processing device 12 receives a request from the mobile terminal 10 or the electronic device 14 by using a general purpose protocol, such as an HTTP(S) request. The information processing device 12 processes the received request, and outputs a result. The information processing device 12 connects to the relay server 16 at each predetermined time interval; and the information processing device 12 confirms whether a request directed to the information processing device 12 is stored in the relay server 16. In response to detecting that a request directed to the information processing device 12 is stored in the relay server 16, the information processing device 12 obtains the request from the relay server 16. The information processing device 12 executes a process corresponding to the obtained request, such as a file type conversion process, a print process, a facsimile transmission process, a mail transmission process, or a process of transmitting a processing command (e.g., a print command, a projection command, or a display command) to another electronic device (e.g., the MFP, the projector, or the IWB). The information processing device 12 transmits, for example, a processing result and necessary data to the relay server device 16. The information processing device 12 communicates with the registered mobile terminal 10. However, the information processing device 12 may not communicate with the mobile terminal 10 that is not registered. Additionally, the information processing device 12 counts a number of times that a function included in the information processing device 12 is used; and the information processing device 12 transmits the number of times to the log server device 20. Furthermore, the information processing device 12 connects to the content server device 18 at each predetermined time interval; and upon detecting that there is a content that is to be downloaded, the information processing device 12 downloads the content.

The mobile terminal 10 is an example of a terminal device that is operated by a user. The mobile terminal 10 may be a smartphone, a tablet terminal, or a mobile telephone, for example. For example, the mobile terminal 10 can display a list of files and contents of the files stored in the information processing device 12. The mobile terminal 10 may receive setting change with respect to the information processing device 12. Here, for receiving the setting change with respect to the information processing device 12 from the mobile terminal 10, the information processing device 12 may receive the setting change depending on a determined right of a user.

The mobile terminal 10 can register the mobile terminal 10 itself in the information processing device 12. The mobile terminal 10 communicates with the information processing device 12 in which the mobile terminal 10 itself is registered through various types of networks. In response to detecting that the mobile terminal 10 is connected to the information processing device 12, the mobile terminal 10 can receive content data. The mobile terminal 10 can display the content data as a banner advertisement in a dedicated area. For example, link information may be embedded in the banner advertisement. In response to detecting that the banner advertisement is clicked by a user, the content data displayed by the mobile terminal 10 can be switched to data indicated by a specific address of the information processing device 12.

In FIG. 1, for establishing a connection between the mobile terminal 10 and the information processing device 12, a LAN connection or a mobile network connection using a data line (a mobile telephone network) of a mobile operator, such as a data line based on 3G or 4G, can be used. In this manner, the mobile terminal 10 can be connected to the information processing device 12 through two different networks.

The content server device 18 stores content data. The content server device 18 may store, for each information processing device 12, corresponding content data. Alternatively or additionally, the content server device 18 may store, for the information processing devices 12 corresponding to a range of certain serial numbers or a range of specified destinations, corresponding content data.

For example, soon after shipping of the information processing device 12, a usage status of the information processing device 12 is not stored in the log server device 20. Thus, the content server device 18 provides the information processing device 12 with general purpose content data at that moment.

For a case where the information processing device 12 has been used by a user for a sufficient time period, a usage status of the information processing device 12 may be stored in the log server device 20. Thus, the content server device 18 provides content data depending on the usage status to the information processing device 12. Upon detecting that the content server device 18 is accessed by using a protocol, such as the WebAPI, the content server device 18 can transmits, to the information processing device 12, an address of the storage of the content data and date and time of updating the content data, for example.

By including a serial number or destination information of the information processing device 12 in an argument for accessing, by using the WebAPI, the content server device 18 by the information processing device 12, the content server device 18 can recognize the individual information processing device 12. Thus, the content server device 18 can report an address of the storage of the content data corresponding to a usage status that is aggregated by the aggregation server device 22 and a display condition, which is described below.

A location for storing content data by the content server device 18 can be divided into several locations. For example, the location for storing content data can be divided into a location for storing general purpose content data; a location for storing specific content data for a specific destination; a location for storing specific content data corresponding to a range of serial numbers; and a location for storing specific content data for the specific information processing device 12, at that time. Here, the location for storing the content data can be specified by a return value of the WebAPI at a moment at which the information processing device 12 accesses the content server device 18.

The log server device 20 stores aggregation data of a number of times of using a function and history data, which are received from the information processing device 12. In accordance with a predetermined format, the log server device 20 receives, from the information processing device 12, the aggregation data of the number of times of using the function and the history data, at each predetermined time period.

The log server device 20 stores, including past data, aggregation data of a number of times of using a function of the information processing device 12 and history data. The log server device 20 may supports a database language, such as the SQL, so that a number of times of using a function of the information processing device 12 can be aggregated as the aggregation data, in accordance with units of the information processing device 12, units of the function, and/or units of the destination. Then, in response to a query, corresponding necessary data may be output.

The aggregation server device 22 periodically obtains aggregation data of the log server device 20; and the aggregation server device 22 calculates a tendency and statistics of predetermined data. The aggregation server device 22 can calculate a tendency and statistics of data from various aspects, such as a number of times of using a function, a time zone of using the function, the individual user, and aggregation data in each information processing device 12 of the plurality of information processing devices 12. Here, a pattern of the tendency and the statistics of the data that is calculated by the log server device 20 is predetermined. However, the pattern can be easily extended by adding and/or modifying a query.

The information processing system 1 illustrated in FIG. 1 is for exemplifying purposes only. For example, the information processing system 1 may be configured so that the relay server device 16 is distributed among a plurality of computers. FIG. 1 illustrates the example where only one information processing device 12 is included in the information processing system 1. However, two or more information processing devices 12 may be included in the information processing system 1. FIG. 1 illustrates the example where only one mobile terminal 10 is included in the information processing system 1. However, two or more mobile terminals 10 may be included in the information processing system 1.

FIG. 1 illustrates the example where the content server device 18, the log server device 20, and the aggregation server device 22 are separated devices. However, the content server device 18, the log server device 20, and the aggregation server device 22 may be implemented by a single device. Alternatively, the content server device 18, the log server device 20, and the aggregation server device 22 may be implemented by a plurality of devices based on a different grouping. The configuration of the information processing system 1 is not limited to the configuration that is illustrated in FIG. 1. The information processing system 1 may include another configuration. As described above, the information processing system 1 illustrated in FIG. 1 is for exemplifying purposes only, and the information processing system 1 may be configured in a different manner, depending on usage and a purpose.

<Hardware Configuration>

<<Computer>>

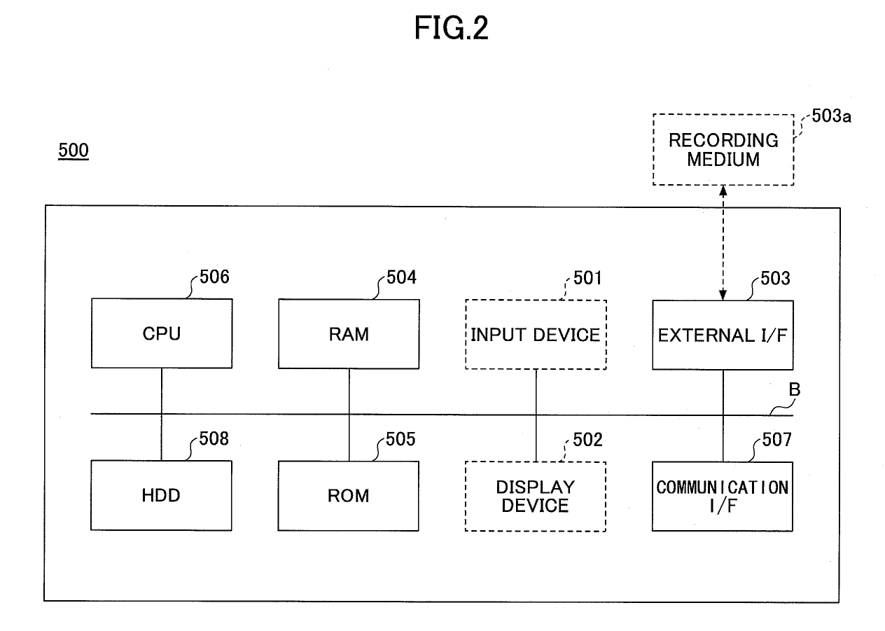

Each of the information processing device 12, the relay server device 16, the content server device 18, the log server device 20, and the aggregation server device 22 may be implemented, for example, by a computer having a hardware configuration illustrated in FIG. 2. FIG. 2 is a diagram illustrating an example of a hardware configuration of the computer according to the embodiment.

The computer 500 of FIG. 2 may include, for example, an input device 501; a display device 502; an external interface (I/F) 503; a RAM 504; a ROM 505; a CPU 506; a communication I/F 507; and a HDD 508, which are mutually connected by a bus B. Here, the input device 501 and the display device 502 may be detachably attached to the computer 500, so that the input device 501 and the display device 502 can be connected to the computer 500 depending on necessity.

The input device 501 may include a keyboard, a mouse, and a touch panel. The input device 501 is used, by a user, for inputting various types of operation signals. The display device 502 may include a display, for example. The display device 502 displays a processing result by the computer 500.

The communication I/F 507 is an interface for connecting the computer 500 to various types of networks. Through the communication I/F 507, the computer 500 can execute data communication.

The HDD 508 is an example of a non-volatile storage device that stores one or more programs and data. The one or more programs and data that are stored in the HDD 508 may include, for example, an operating system (OS) that is system software for controlling the entire computer 500; and application software (which may be simply referred to as an application, hereinafter) for providing various functions on the OS. Here, instead of the HDD 508, the computer 500 may utilize a drive device (e.g., a solid state drive (SSD)) that uses a flash memory as a storage medium.

The external I/F 503 is an interface with an external device. The external device may be, for example, a recording medium 503a. Through the external I/F 503, the computer 500 can read out data in the recording medium 503a, and write data in the recording medium 503a. As examples of the recording medium 503a, there are a flexible disk, a CD, a DVD, a SD memory card, and a USB memory.

The ROM 505 is an example of a non-volatile semiconductor memory (storage device) that can maintain a program and data, even if the power supply of the computer 500 is turned off. The ROM 505 stores one or more programs and data, such as the BIOS that is executed at activation of the computer 500, settings of the OS, and network settings. The RAM 504 is an example of a volatile semiconductor memory (a storage device) that temporarily maintains one or more programs and data.

The CPU 506 is a processor for controlling the entire computer 500 and for implementing functions of the computer 500 by reading out one or more programs and data from the storage device, such as the ROM 505 and the HDD 508, onto the RAM 504, and by executing one or more processes.

By the hardware configuration of the computer 500 illustrated in FIG. 2, for example, each of the information processing device 12, the relay server 16, the content server device 18, the log server device 20, and the aggregation server device 22 can execute various types of processes, which are described below.

<Software Configuration>

<<Information Processing Device>>

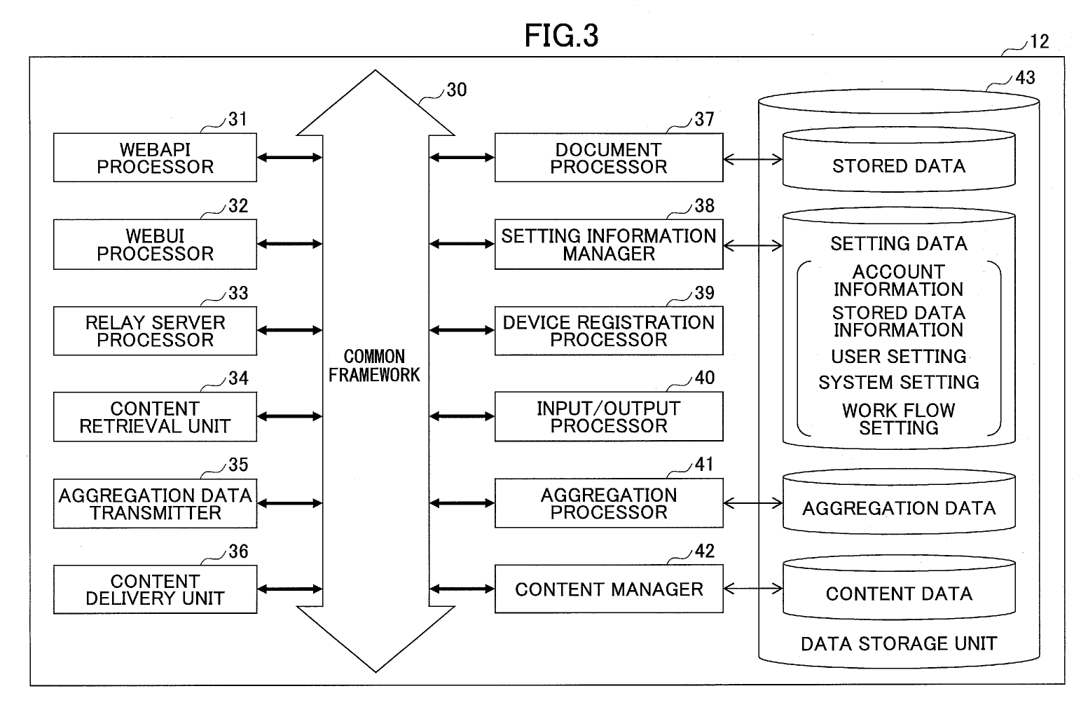

The information processing device 12 according to the embodiment may be configured as illustrated in FIG. 3, for example. FIG. 3 is a diagram illustrating an example of processing blocks of the information processing device 12 according to the embodiment. By executing one or more programs, the information processing device 12 may implement a common framework 30; a WebAPI processor 31; a WebUI processor 32; a relay server processor 33; a content retrieval unit 34; an aggregation data transmitter 35; a content delivery unit 36; a document processor 37; a setting information manager 38; a device registration processor 39; an input/output processor 40; an aggregation processor 41; a content manager 42; and a data storage unit 43.

The common framework 30 may provide a function for the plurality of software components in the information processing device 12 to communicate. The common framework 30 is used for transmitting and receiving a request and data. The WebAPI processor 31 may control HTTP(S) requests, through the WebAPI, from the mobile terminal 10, the electronic device 14, and a client PC, which are connected to a network. Additionally, the WebAPI processor 31 may control requests, through the WebAPI, that are to be transmitted, for example, to the content serve device 18.

The Web application programming interface (WebAPI) is a predefined interface that is provided for receiving requests from the mobile terminal 10 and the electronic device 14, for example. The WebAPI may be formed of functions and classes, for example. After serializing the received request for each request source, the WebAPI processor 31 transmits the received request to corresponding processors through the common framework 30.

The WebUI processor 32 controls a content that is displayed by a Web server included in the information processing device 12. The Web UI processor 32 constructs, for each user, a displayed content corresponding to the setting information and a content of a file. In response to detecting that the downloaded content data includes content data for the WebUI, the WebUI processor 32 displays, upon detecting that a user accesses the WebUI, a banner advertisement in an advertisement area, such as a lower portion of a page, by using the content data for the WebUI.

The relay server processor 33 monitors whether there is a stored request in the relay server device 16 at each predetermined time interval. Upon detecting that there is a request stored in the relay server device 16, the relay server processor 33 obtains the request from the relay server device 16, and the relay server processor 33 transmits the request to corresponding one or more processors. The relay server processor 33 receives, from the one or more processors, a processing result corresponding to the request transmitted to the one or more processors; and the relay server processor 33 reports the processing result to the relay server device 16.

The content retrieval unit 34 downloads, by using the WebAPI processor 31, content data required by the information processing device 12 from the content server device 18. The content retrieval unit 34 sets, for example, a serial number and destination information of the information processing device 12 as an augment of the WebAPI; and the content retrieval unit 34 accesses (transmits a request to) the content server device 18.

The content retrieval unit 34 can retrieve, as a response from the content server device 18, an address of the storage of the content data, which is to be retrieved by the information processing device 12, for example. Not only the content data for the banner advertisement, but also a correction patch for the information processing device 12 may be obtained from the retrieved address of the storage. Namely, the information processing device 12 can process, for example, the correction patch as a part of the content data.

The aggregation data transmitter 35 transmits, to the log server device 20, aggregation data that is stored in the data storage unit 43 by the aggregation processor 41, at each predetermined time interval. Upon successfully transmitting the aggregation data to the log server device 20, the aggregation data transmitter 35 resets the aggregation data stored in the data storage unit 43. By executing the process of transmitting the aggregation data to the log server device 20 at each predetermined time interval, the aggregation data transmitter 35 can cause the log server device 20 to execute quantitative aggregation.

Upon detecting, through the WebAPI processor 31 or the WebUI processor 32, a request to retrieve content, the content delivery unit 36 is used. The content delivery unit 36 delivers a content corresponding to the user and/or the device (the input/output device), such as the mobile terminal 10 or the electronic device 14, at the time at which the request to retrieve the content is input. For a case where the mobile terminal 10 or the electronic device 14 is used, the content delivery unit 36 delivers the content data via a network. For a case of the WebUI, the content data is displayed in an advertisement area of the screen of the WebUI.

The document processor 37 maintains, as a stored data, a file that is stored in the information processing device 12. The stored data may be a file that is stored in the data storage unit 43 from the client PC through the SMB, or a file that is created by the information processing device 12. In addition to the maintenance of the stored data, the document processor 37 may convert a format of the stored data.

The conversion of the format of the stored data may include conversion of the image format, and conversion from a specific application type. The document processor 37 may also maintains the stored data for which the format is converted.

The setting information manager 38 maintains, in the data storage unit 43, for example, account information, stored data information, user settings, system settings, and workflow settings, as setting information. The setting information may include user setting information and system setting information.

The account information includes, for example, information for identifying the registered mobile terminals 10, identification information (user names and user specific numbers) of users of the mobile terminals 10, authentication information (IDs and passwords) of the users. The stored data information includes, for each of the stored data items stored in the information processing device 12, a data format, a data name, a data amount, date and time of update, a type of the converted data format, a file viewing date of each user (or each mobile terminal 10), and so forth. The user setting includes information on a specific setting of each user. The system setting includes information specific to devices, a setting that is common for all users, and so forth. The work flow setting is a setting on a work flow.

The device registration processor 39 is a processor for registering the mobile terminal 10. The device registration processor 39 displays, through the WebUI, a two-dimensional bar code that includes information required for device registration. The mobile terminal 10 can obtain information for establishing a connection to the information processing device 12, for example, by reading, by a camera function of the mobile terminal 10, the two-dimensional bar code that is displayed on the WebUI of the information processing device 12, and by decoding the two-dimensional bar code.

The input/output processor 40 executes cooperation processing with input/output devices, such as the mobile terminal 10 and the electronic device 14, which are connected to the information processing device 12. The input/output processor 40 can execute, for example, a process of outputting a printout to the MFP, a facsimile transmission and reception process, and a process of outputting an image to the IWB. The input/output processor 40 is used, by a user, for executing an input/output function of the electronic device 14 through the WebUI and/or the mobile terminal 10. The aggregation processor 41 stores a number of times of using a function and history data in the data storage unit 43.

Upon detecting that any one of the processors is to execute a process, the aggregation processor 41 intermediates the process. The aggregation processor 41 aggregates a number of times of using each of the functions and history data; and the aggregation processor 41 stores, as the aggregation data, the number of times of using each of the functions and the history data in the data storage unit 43. The aggregation data is temporarily processed, so that the usage status can be seen for each function; and the aggregation data is stored in the data storage unit 43.

The content manager 42 maintains content data retrieved from the content server device 18 by the content retrieval unit 34 by storing the content data in the data storage units 43. The content data is maintained as a file in a format corresponding to the input/output device.

For example, for the mobile terminal 10, content data is maintained as image data for a banner advertisement and link information of the mobile terminal 10. For the WebUI, content data is maintained as image data for a banner advertisement that can be displayed by a browser of a client PC and link information. In this manner, content data is maintained as a file in a format corresponding to display capability of an input/output device. The content data may depend on a specific user or a specific device. Alternatively, the content data may be general-purpose content data that does not depend on a specific user or a specific device. The content manager 42 receives a request for storing content data from the content retrieval unit 34; and the content manager 42 stores content data in the data storage unit 43. Further, the content manger 42 receives a request for retrieving content from the content delivery unit 36; and the content manager 42 provides the content delivery unit 36 with the content data read out from the data storage unit 43.

<<Content Server Device>>

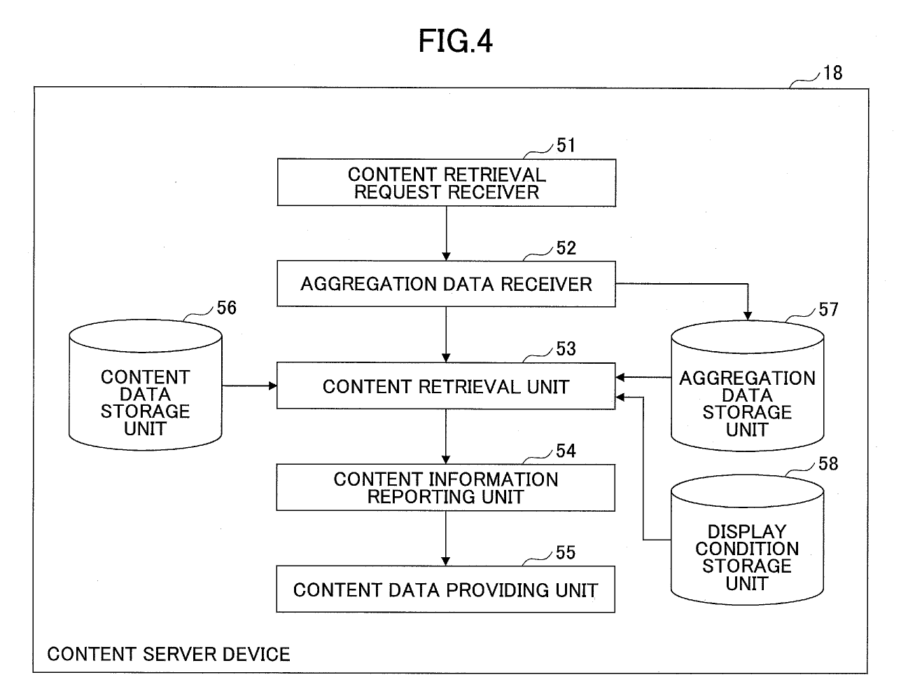

The content server device 18 according to the embodiment can be configured, for example, as illustrate in FIG. 4. FIG. 4 is a diagram illustrating an example of processing blocks of the content server device 18 according to the embodiment.

The content server device 18 implements, by executing one or more programs, a content retrieval request receiver 51; an aggregation data receiver 52; a content retrieval unit 53; a content information reporting unit 54; a content data providing unit 55; a content data storage unit 56; an aggregation data storage unit 57; and a display condition storage unit 58.

Upon receiving a content retrieval request from the information processing device 12, the content retrieval request receiver 51 reports to the aggregation data receiver 52. In response to receiving the report from the content retrieval request receiver 51 that the content retrieval request is received, the aggregation data receiver 52 receives aggregation data from the aggregation server device 22, and the aggregation data receiver 52 stores the aggregation data in the aggregation data storage unit 57.

The content retrieval unit 53 searches for content data stored in the content data storage unit 56, based on the aggregation data stored in the aggregation data storage unit 57 and the display condition stored in the display condition storage unit 58. The content retrieval unit 53 searches for the content data that is required by the information processing device 12. The content information reporting unit 54 repots, to the information processing device 12, content information (e.g., an address of the storage and data and time of update) of the content data detected by the content retrieval unit 53.

The content data providing unit 55 provides the content data that is requested by the information processing device 12. The content data storage unit 56 stores content data. The aggregation data storage unit 57 stores aggregation data received from the aggregation server device 22. The display condition storage unit 58 stores display condition information, which is described below.

<Details of the Process>

In the following, details of the process executed by the information processing system 1 according to the embodiment are described.

<<Process of Delivering the Content Data by the Information Processing Device>>

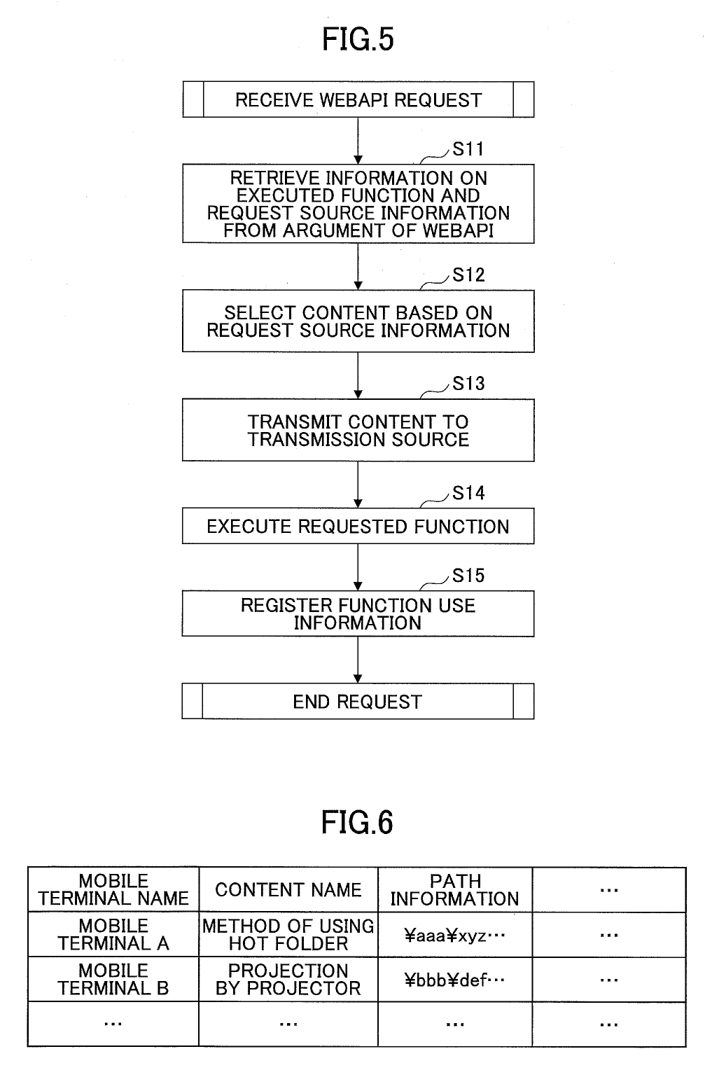

FIG. 5 is a flowchart of an example of a content delivery process by the information processing device 12. Upon receiving a request through the WebAPI, the information processing device 12 starts executing the process of the flowchart of FIG. 5. Note that the information processing device 12 can recognize, for example, that the request is from which device, and that the application is the application of which version because the request through the WebAPI includes information on the function to be executed, the user account information, the device information on the source of the transmission, the application information, and so forth.

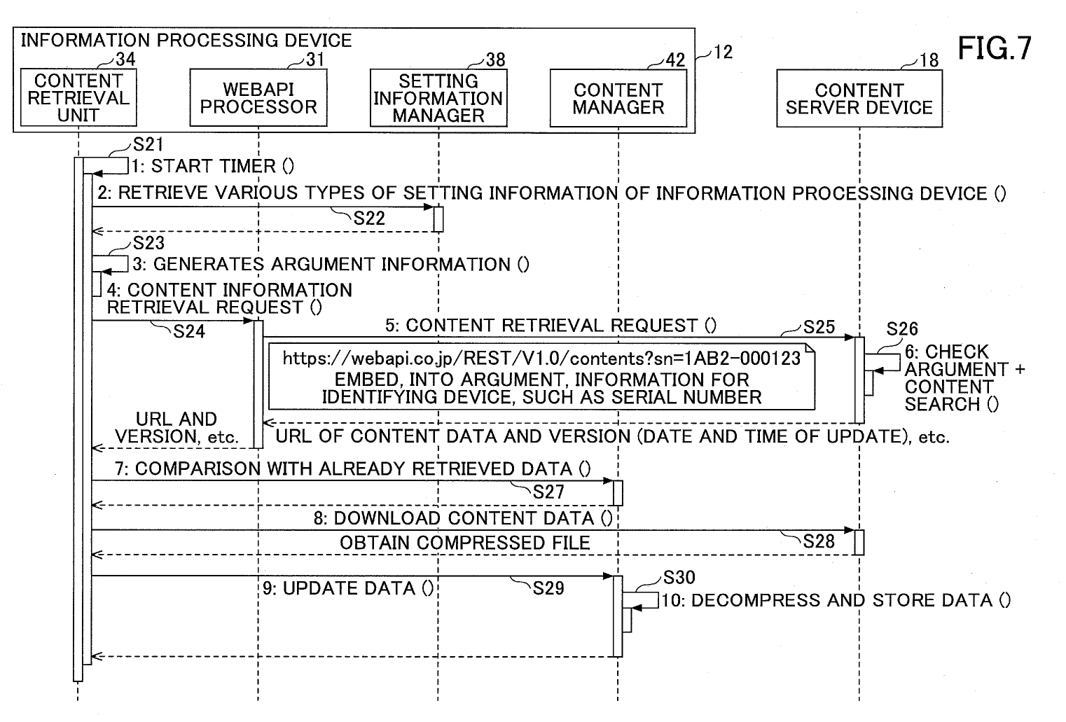

At step S11, the information processing device 12 obtains information on the function to be executed and the information on the source of the transmission from the argument of the WebAPI. At step S12, the information processing device 12 selects the content data based on the request source information. Here, the information processing device 12 selects the content data corresponding to the device that is identified by the request source information by using the table, which is illustrated in FIG. 6, for example. FIG. 6 is a diagram illustrating an example of an arrangement of the table that defines correspondence between the devices and the content data items.

The table of FIG. 6 defines the correspondence among a mobile terminal name, a content name, and path information. The mobile terminal name is an example of the request source information, and the mobile terminal name is an example of the information for identifying the device. The content name and the path information is an example of the information for identifying the content data. By using the table of FIG. 6, the information processing device 12 can select the content data corresponding to the device that is identified by the request source information.

At step S13, the information processing device 12 transmits the content data selected at step S12 to the device that is identified by the request source information. However, the information processing device 12 may select default content data that is prepared in advance, if the information processing device 12 does not retrieve content data, or if the retrieved content data is old.

The content data can be delivered to the device that is identified by the request source information, as a part of a WebAPI response. The receiving device can receive the content data as the image data corresponding to the banner advertisement or the link information to be clicked. In the mobile terminal 10, an advertisement area is determined. Thus, the mobile terminal 10 can display the content data in the advertisement area, while the user is operating the application of the mobile terminal 10. At step S14, the information processing device 12 executes a function requested through the WebAPI; and the information processing device 12 transmits the processing result to the device that is identified by the request source information. Further, at step S15, based on the processing result, the information processing device 12 registers (stores) function use information, such as a number of times of using a function and history data, as the aggregation data.

Note that, for a case where the device that is identified by the request source information is the client PC, the WebAPI of the process of FIG. 5 is replaced with the WebUI. However, the process is the same. Namely, the information processing device 12 connects the client PC through the WebUI, and after that, the information processing device 12 can identify a user from the browser information and the log-in account information of the client PC, for example, by JavaScript (registered trademark) that is embedded in the WebUI.

Then, the information processing device 12 selects and delivers (only displays, for the case of the WebUI) the content data based on the request source information. The information processing device 12 executes the requested function, and displays the processing result. The information processing device 12 registers (stores) the function use information, such as the number of times of using a function and the history data, as the aggregation data.

<<The Process of Retrieving Content Data by the Information Processing Device>>

FIG. 7 is a sequence diagram illustrating an example of a process, by the information processing device 12, of retrieving content data from the content server device 18. At step S21, the content retrieval unit 34 starts a timer to measure a predetermined time interval, so that the content retrieval unit 34 can connect to the content server device 18 at each predetermined time interval.

After the predetermined time interval elapses, the content retrieval unit 34 retrieves, at step S22, various types of setting information of the information processing device 12 from the setting information manager 38. At step S23, the content retrieval unit 34 generates argument information of the WebAPI by using various types of setting information of the information processing device 12 (e.g., the serial number and the destination information of the information processing device 12) retrieved at step S22.

At step S24, the content retrieval unit 34 transmits, to the WebAPI processor 31, a content information retrieval request specifying the argument information generated at step S23. At step S25, the WebAPI processor 31 sets the argument of the WebAPI to the specified argument information; and the WebAPI processor 31 transmits a content retrieval request to the content server device 18.

As described below, at step S26, the content server device 18 searches for the content data, which is to be stored by the information processing device 12, in the argument of the WebAPI, in the aggregation data, and in the display condition. The content server device 18 reports, to the WebAPI processor 31 of the information processing device 12, the URL and the version information (e.g. date and time of update) of the detected content data, as the content information of the content data to be stored.

At step S27, the content retrieval unit 34 requests the content manager 42 to compare the content information of the content data to be stored, which is reported from the content server device 18, with the content information of the content data that has already been retrieved. For example, the content manager 42 selects the content data to be downloaded by comparing the version that is included in the content information reported from the content server device 18 with the version that is included in the content information of the content data that has already been retrieved. The process at step S27 is not limited to the comparison of the versions. It suffices if, by the process at step S27, the content data to be downloaded can be selected from the content data stored in the content server device 18.

The content manager 42 reports, to the content retrieval unit 34, the content data to be downloaded. At step S28, the content retrieval unit 34 downloads, from the content server device 18, a compressed file of the content data to be downloaded. At step S29, the content retrieval unit 34 requests the content manager 42 to update the content data by using the downloaded compressed file.

At step S30, the content manager 42 decompresses the compressed file. The content manager 42 stores the decompressed content data in the data storage unit 43. By such a process, the content manager 42 can update the content data stored in the data storage unit 43 with the content data to be stored in the information processing device 12.

<<Details of Step S26>>

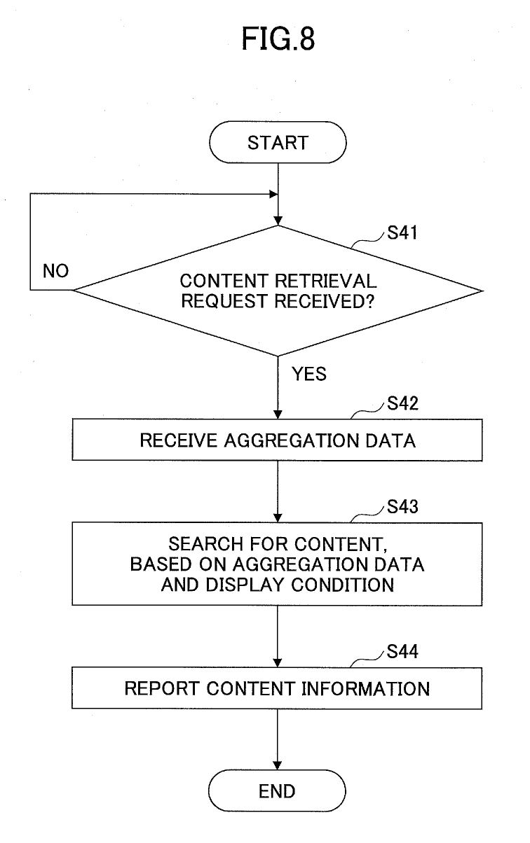

FIG. 8 is a flowchart illustrating an example of details of the process at step S26. The content server device 18 repeats the process of step S41 until a content retrieval request is received from the information processing device 12.

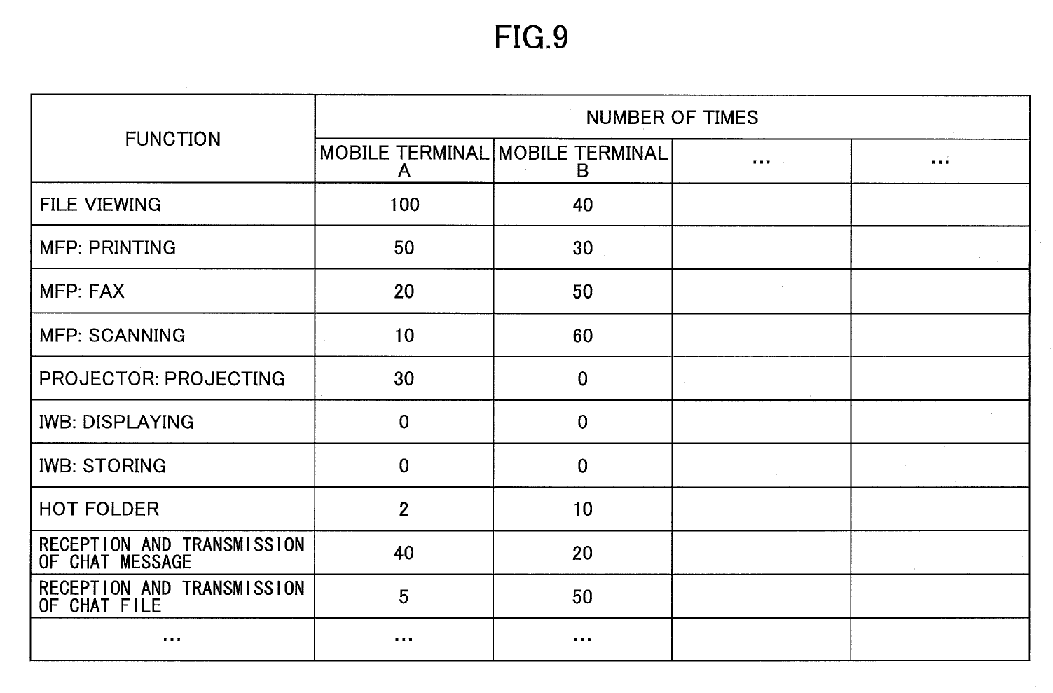

In response to detecting that the content retrieval request receiver 51 receives a content retrieval request from the information processing device 12, the aggregation data receiver 52 receives, at step S42, the aggregation data from the aggregation server device 22; and the aggregation data receiver 52 stores the aggregation data in the aggregation data storage unit 57. Note that the aggregation data to be stored in the aggregation data storage unit 57 may be arranged as illustrated in FIG. 9, for example.

FIG. 9 is a diagram illustrating an example of an arrangement of the aggregation data. The aggregation data of FIG. 9 indicates, for each function provided to the mobile terminal 10 by the information processing device 12, the number of times of using the function by each of the mobile terminals 10. Here, as illustrated in FIG. 9, the functions that are provided to the mobile terminal 10 by the information processing device 12 include functions that are provided by the information processing device 12 by using the electronic device 14, such as a print function and a projection function.

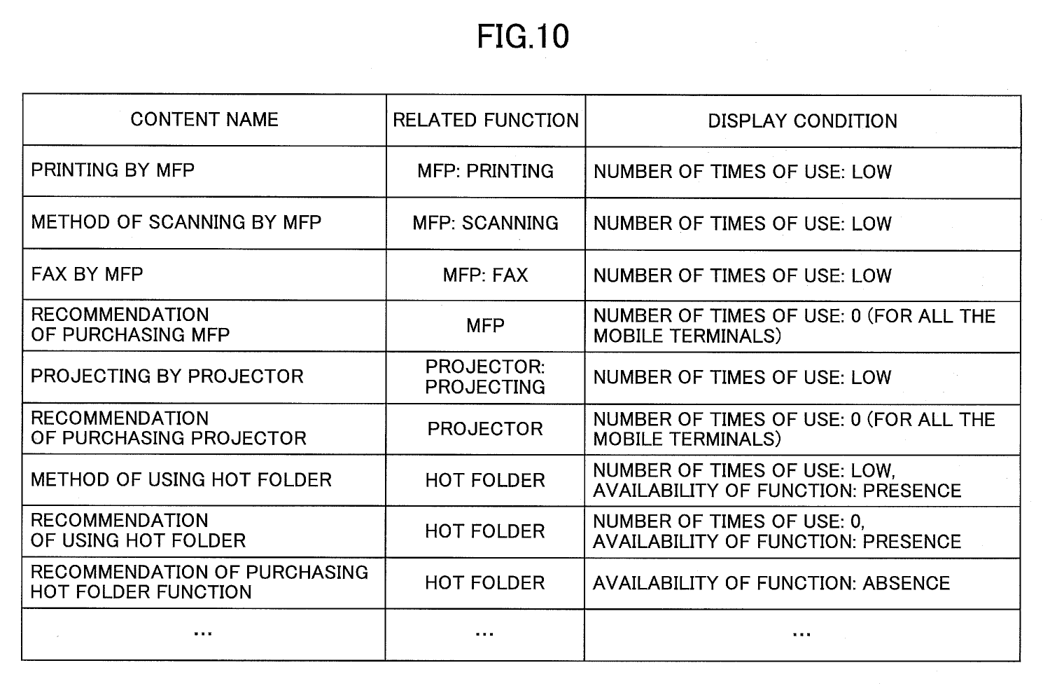

At step S43, the content retrieval unit 53 searches for the content data stored in the content data storage unit 56, based on the aggregation data illustrated in FIG. 9 and the display condition stored in the display condition storage unit 58. Here, the display condition information stored in the display condition storage unit 58 may be arranged, for example, as illustrated in FIG. 10.

FIG. 10 is a diagram illustrating an example of an arrangement of the display condition information. The display condition information of FIG. 10 indicates, for each function (related function) provided to the mobile terminal 10 by the information processing device 12, a display condition for displaying content data and a content name of the content data that is selected upon detecting that the display condition is satisfied. The display condition for displaying the content data is represented by a usage status of a function by a user, such as the number of times of use is “low” or “0”, and availability of a function, e.g., “presence” or “absence.”

For example, the usage status of “the number of times of use: low” indicates that the number of times of using the function indicated by the related function is smaller than a predetermined value or an average value. The usage status of “the number of times of use: 0 (for all the mobile terminals)” indicates that the number of times of using the function indicated by the related function is “0” for all the mobile terminals 10 that are registered in the information processing device 12.

The usage status of “availability of function: absence” indicates that the function indicated by the related function is not available (i.e., the function is not activated). The usage status illustrated in FIG. 10 is for exemplifying purposes only. For example, the usage status may be “the number of times of use: high” or “the number of times of use: less than or equal to ten times.”

The content data that is searched for at step S43 is the content data that is desirable to be displayed by the mobile terminal 10, based on the usage status of the function, by the mobile terminal 10, of the information processing device 12. In other words, the content data to be searched for at step S43 may be stored in the information processing device 12, and the content data is to be delivered to the mobile terminal 10.

At step S43, if there are a plurality of content data items that satisfy the display condition, the plurality of content data items may be detected. Then, at step S44, the content information reporting unit 54 reports the content information (e.g., the address of the storage and the date and time of update) of the content detected at step S43 to the information processing device 12.

In this manner, the content server device 18 can report, to the information processing device 12, the content information of the content data to be stored in the information processing device 12. In response to detecting that the content data to be stored is received, the information processing device 12 may create a table, such as the table illustrated in FIG. 6. The information processing device 12 may associate the device information with the content to be delivered, and the information processing device 12 may store the device information and the associated content data.

<<Process of Delivering the Content Data by the Information Processing Device>>

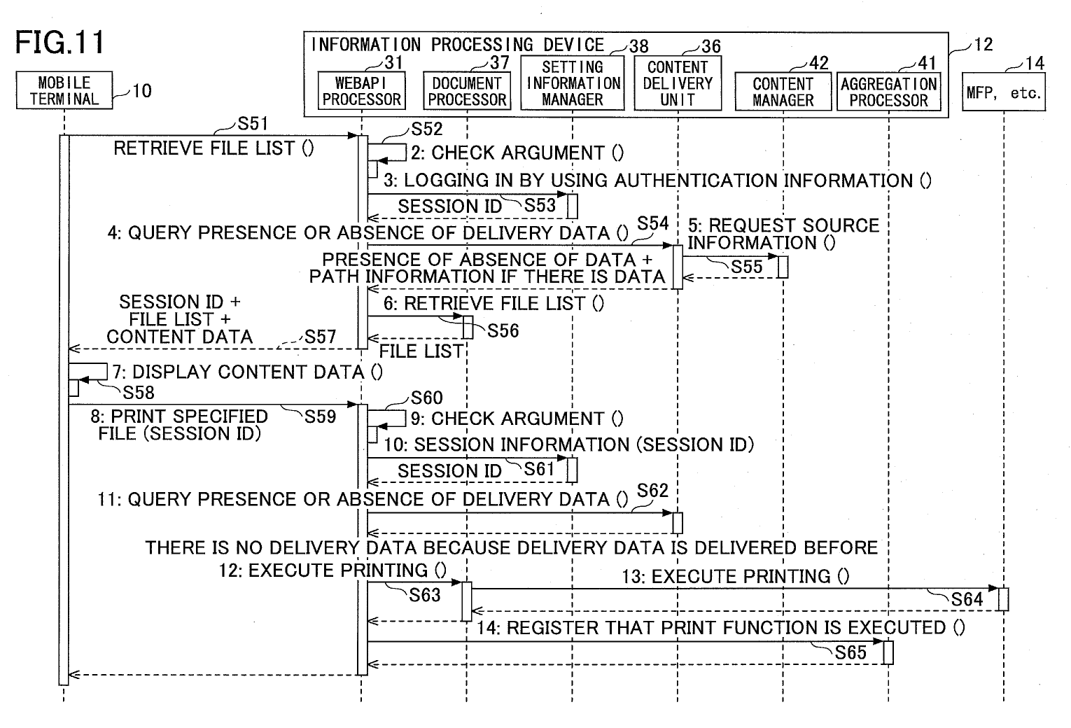

FIG. 11 is a sequence diagram illustrating an example of a process, by the information processing device 12, of delivering content data to the mobile terminal 10. At step S51, the WebAPI processor 31 of the information processing device 12 receives, through the WebAPI, a file list retrieval request from the mobile terminal 10. At step S52, the WebAPI processor 31 checks an argument of the WebAPI.

At step S53, the WebAPI processor 31 requests to log in to the setting information manager 38 by using authentication information, and the WebAPI processor 31 obtains a session ID. At step S54, the WebAPI processor 31 queries, to the content delivery unit 36, whether there is content data to be delivered (delivery data). At step S55, the content delivery unit 36 queries, to the content manager 42, whether there is content data to be delivered by specifying request source information (the mobile terminal 10).

The content delivery unit 36 reports, to the WebAPI processor 31, presence or absence of the content to be delivered and the path information (if there is the content data). At step S56, the WebAPI processor 31 requests a file list from the document processor 37, and the WebAPI processor 31 retrieves the file list.

At step S57, the WebAPI processor 31 transmits, to the mobile terminal 10, the session ID, the file list, and the content data. Then, at step S58, the mobile terminal 10 displays the content data together with the file list.

At step S59, the mobile terminal 10 requests the WebAPI processor 31 of the information processing device 12 to print the file specified by a user. The WebAPI processor 31 of the information processing device 12 receives, through the WebAPI, a print request from the mobile terminal 10. At step S60, the WebAPI processor 31 checks the argument of the WebAPI.

At step S61, the WebAPI processor 31 causes the setting information manager 38 to determine the validity of the session ID. In response to determining that the session ID is valid, the WebAPI processor 31 queries (at step S62), to the content delivery unit 36, whether there is content data to be delivered (delivery data). However, there is no content data to be delivered because the content data is delivered before.

At step S63, the WebAPI processor 31 requests the document processor 37 to print the data. At step S64, the document processor 37 causes the electronic device 14, such as the MFP, to print the requested data by transmitting the stored data to be printed. At step S65, the WebAPI processor 31 updates, in accordance with use of the print function, the number of times of using the print function and the history data of the aggregation data stored in the data storage unit 43.

The information processing device 12 according to the embodiment can select content data depending on a usage status of a function of the information processing device 12, such as the number of times of using the function; and the information processing device 12 can cause a device, such as the mobile terminal 10, to display the selected content. As examples of the content data to be displayed by the device, such as the mobile terminal 10, there is content data that introduces a function if the number of times of using the function is “0,” and there is content data that introduces how to use a function if the number of times of using the function is small compared with the number of times of using another function.

Additionally, as the content data to be displayed by a device, such as the mobile terminal 10, there is content data that introduces an application method of using a function if the number of times of using the function is greater than the number of times of using another function.

Thus, a user can view a banner advertisement that displays the content data that introduces a function not used by the user before, among the functions that are provided to the device, such as the mobile terminal 10, by the information processing device 12. In this manner, when a user is not aware of an added function (a new function), such as a case where a new function is added to the information processing device 12, by displaying a banner advertisement, a utilization rate of the new function can be increased and awareness of the new function can be enhanced.

Additionally, a user can view a banner advertisement that displays the content data that introduces a method of using a function, if the number of times of using the function is small compared with the number of times of using another function. In this manner, the information processing device 12 can introduce a method of using a function, if the rate of using the function by a user is small. By introducing the method of using the function, it can be expected that a rate of using the function by the user can be increased.

In this manner, depending on a usage status of a function that is provided to a device, such as the mobile terminal 10, by the information processing device 12, the information processing device 12 can cause the device to display a banner advertisement of a function, if a rate of using the function by a user is small, or a banner advertisement of a function that may not be recognized by the user.

With the information processing device 12 according to the embodiment, it can be expected that rates of using functions of the information processing device 12 can be increased by using the banner advertisement, for example, to provide a detailed explanation of the functions of the information processing device 12, to propose to use the functions with low utilization rates, or to appeal the functions.

### Another Embodiment

In the above-described embodiment, an example is described where the information processing device 12 is connected to the content server device 18, the log server device 20, and the aggregation server device 22, through a network, such as the Internet. In the information processing system 1 according to the above-described embodiment, it is possible to store aggregation data and history data that are received from a plurality of information processing devices 12. Thus, the content server device 18 can use the aggregation data that is received from the plurality of information processing devices 12 to search for content data to be displayed by the mobile terminal 10.

As another embodiment, a configuration can be considered where the information processing device 12 includes the function of the content server device 18. As another embodiment, a configuration can be considered where the information processing device 12 includes the function of the content server device 18, the function of the log server device 20, and the function of the aggregation server device 22.

With the configuration where the information processing device 12 includes the function of the content server device 18, the function of the log server device 20, and the function of the aggregation server device 22, a small and less expensive information processing system 1 can be achieved.

The information processing device, the content delivery method, and the non-transitory storage medium storing the information processing program are described above by the embodiments. However, the present invention is not limited to the embodiments, and various modifications and improvements may be made within the scope of the present invention. Specific examples of numerical values are used in order to facilitate understanding of the invention. However, these numerical values are simply illustrative, and any other appropriate values may be used, except as indicated otherwise. The separations of the items in the above-described explanation are not essential to the present invention. Depending on necessity, subject matter described in two or more items may be combined and used, and subject matter described in an item may be applied to subject matter described in another item (provided that they do not contradict). A boundary of a functional unit or a processing unit in a functional block does not necessarily correspond to a boundary of a physical component. An operation by a plurality of functional units may be physically executed by a single component. Alternatively, an operation by a single functional unit may be physically executed by a plurality of components. For the convenience of explanation, the devices according to the embodiment of the present invention are explained by using the functional block diagrams. However, these devices may be implemented in hardware, software, or combinations thereof. The software that operates in accordance with the present invention may be prepared in any appropriate storage medium, such as a random access memory (RAM), a flash memory, a read-only memory (ROM), an EPROM, an EEPROM, a register, a hard disk drive (HDD), a removable disk, a CD-ROM, a database, a server, and the like.

The present invention can be implemented in any convenient form, for example using dedicated hardware, or a mixture of dedicated hardware and software. The present invention may be implemented as computer software implemented by one or more network processing apparatuses. The network can comprise any conventional terrestrial or wireless communications network, such as the Internet. The processing apparatuses can compromise any suitable programmed apparatuses such as a general-purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, a hard disk, a CD ROM, a magnetic tape device or a solid state memory device. The hardware platform includes any desired hardware resources including, for example, a central processing unit (CPU), a random access memory (RAM), and a hard disk drive (HDD). The CPU may include processors of any desired kinds and numbers. The RAM may include any desired volatile or nonvolatile memories. The HDD may include any desired nonvolatile memories capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

The information processing device 12 is an example of the information processing device. The mobile terminal 10 is an example of the terminal device. The content manager 42 is an example of the content manager. The WebAPI processor 31 is an example of the request receiver.

The present application is based on and claims the benefit of priority of Japanese Priority Application No. 2015-056205 filed on Mar. 19, 2015, the entire contents of which are hereby incorporated herein by reference.

What is claimed is:

1. An information processing device configured to provide one or more functions to one or more terminal devices, the information processing device comprising:
a content manger configured to store, for each of the one or more terminal devices, content data that is selected depending on a status of using each of the one or more functions by the terminal device in a data storage unit, while associating the content data with the terminal device; and
a request reception processor configured to receive a request for processing from a specific terminal device of the one or more terminal devices, and configured to transmit, to the specific terminal device that is a request source, the content data associated with the specific terminal device, together with a processing result corresponding to the request.

2. The information processing device according to claim 1,
wherein the content manager is configured to select, based on aggregation data that indicates, for each of the one or more functions to be provided to the one or more terminal devices, the status of using the function by each of the one or more terminal devices, and based on display condition information indicating, for each of the one or more functions, a display condition for displaying the content data and the content data that is selected if the display condition is satisfied, the content data that satisfies the display condition, from the statuses of using the one or more functions by each of the one or more terminal devices.

3. The information processing device according to claim 2,
wherein each of the display conditions is represented by a number of times of using the corresponding function.

4. The information processing device according to claim 2,
wherein each of the display conditions is represented by information indicating whether the corresponding function by the terminal device is activated.

5. The information processing device according to claim 1,
wherein the content manager is configured to select the content data for a specific function of the one or more functions such that a number of times of using the specific function in the terminal device is less than or equal to a predetermined number.

6. The information processing device according to claim 1,
wherein at least one function of the one or more functions to be provided to the one or more terminal devices is provided by using an electronic device.

7. A content delivery method to be executed by an information processing device configured to provide one or more functions to one or more terminal devices, the content delivery method comprising:
storing, for each of the one or more terminal devices, content data that is selected depending on a status of using each of the one or more functions by the terminal device in a data storage unit, while associating the content data with the terminal device; and
receiving a request for processing from a specific terminal device of the one or more terminal devices, and transmitting, to the specific terminal device that is a request source, the content data associated with the specific terminal device, together with a processing result corresponding to the request.

8. A non-transitory storage medium storing an information processing program, wherein an information processing device is configured to provide one ore more functions to one or more terminal devices, and the program causes the information processing device to function as:
a content manger configured to store, for each of the one or more terminal devices, content data that is selected depending on a status of using each of the one or more functions by the terminal device in a data storage unit, while associating the content data with the terminal device; and
a request reception processor configured to receive a request for processing from a specific terminal device of the one or more terminal devices, and configured to transmit, to the specific terminal device that is a request source, the content data associated with the specific terminal device, together with a processing result corresponding to the request.
